(19) United States
(12) Patent Application Publication
(10) Pub. No.: US 2011/0035248 A1
(43) Pub. Date: Feb. 10, 2011

(54) Distributed Service Platform Computing with a Guaranteed Quality of Service

(76) Inventor: Loic Juillard, Escondido, CA (US)

Correspondence Address: LAW OFFICE OF GERALD MALISZEWSKI, P.O. BOX 270829, SAN DIEGO, CA, 92198-2829, US

(21) Appl. No.: 12/537,938

(22) Filed: Aug. 7, 2009

(51) Int. Cl. G06F 15/173; G06Q 10/00; G06Q 50/00; G06Q 30/00

(52) U.S. Cl. 705/8; 709/226

(57) ABSTRACT

A device and method are provided for guaranteeing a quality of service (QoS) for a network-connected device in a distributed service platform (DSP) or cloud computing system. The method establishes a first set of attributes or performance criteria for a selected platform component. The selected platform component may be a system component for processing data or a network component for connecting system components. For example, the first set of attributes may be supplied by a client in an SLA. A second set of attributes is derived for the unselected platform component necessary to support the first set of attributes. For example, if a first set of attributes is established for a system component, then a second set of attributes would be derived or calculated for a network component. As a result, a DSP QoS is supplied to a network-connected (e.g., client) device, guaranteeing the first set of attributes.

### BACKGROUND OF THE INVENTION

1. Field of the Invention

This invention generally relates to cloud computing and, more particularly, to a system and method for providing an end-to-end quality of service (QoS) in a cloud computing or distributed service platform (DSP) environment.

2. Description of the Related Art

Cloud computing is dynamically scalable, offering virtualized resources as a service over the Internet. Generally, the user is able to access these services without any particular knowledge of the cloud technical infrastructure. As one example, a cloud computing service may provide an online application accessed from a web browser, where the software and data are stored on the servers at a location(s) remote from the user.

Cloud computing can be distinguished from grid computing, which is a form of distributed computing where a virtual computer is composed of a cluster of networked, loosely coupled computers, acting in concert to perform very large tasks. Utility computing, on the other hand, supplies a metered service for computing resources, such as computation and storage, and is analogous to a public utility supplying electricity. Peer-to-peer networks such as BitTorrent and Skype, and volunteer computing such as SETI@home are examples of cloud architectures having little or no centralized infrastructure.

Cloud computing customers do not generally own the physical infrastructure serving as host to the software and hardware providing the service. Instead, the users avoid capital expenditure by renting usage from a third-party provider. The user consumes resources as a service and pays only for resources that are actually used. Many cloud-computing offerings employ the utility computing model for billing purposes, while others bill on a subscription basis. Sharing computing power among multiple tenants can improve utilization rates, as servers are not unnecessarily left idle, which can reduce costs significantly while increasing the speed of application development. A side effect of this approach is that overall computer usage rises dramatically, as customers do not have to engineer for peak load limits. Additionally, increased high-speed bandwidth makes it possible to receive the same response times from centralized infrastructure at other sites. Other benefits of this time sharing style approach are low barriers to entry, shared infrastructure and costs, low management overhead, and immediate access to a broad range of applications. Users can generally terminate the contract at any time (thereby avoiding return on investment risk and uncertainty) and the services are often covered by service level agreements (SLAs) with financial penalties.

The majority of cloud computing infrastructure consists of services delivered through data centers and built on servers with different levels of virtualization technologies. The services are accessible anywhere that provides access to networking infrastructure. Clouds often appear as single points of access for all consumers' computing needs. Commercial offerings are generally expected to meet quality of service (QoS) requirements of customers, and they typically offer SLAs.

Currently, virtualized storage only focuses on the storage system, but fails to address the service as a whole. Customers are provided with storage space on a filer, allowing them to expand or move data across difference volumes. But this storage space specification fails to consider the service as a whole. This same analysis can be applied to any particular system or network component. Consequently, in a shared and virtualized environment, each customer's activities can impact service availability and performance for the other customers using the same components and services.

It would be advantageous if a system level QoS, such as a storage capacity, could be guaranteed by simultaneously calculating all the cloud computing resources needed to support the system level QoS.

It would be advantageous if the same end-to-end calculation could be applied to network level, or a combination of network and system level QoSs specified in an SLA.

### SUMMARY OF THE INVENTION

Described herein are a system and method for providing a data structure to bind network quality of service, storage quality of service, and system quality of service. Each component, such as network routers, switches, filers, and shelves, is configured to deliver the service specified, with the expected performance. This methodology implements end-to-end QoS management in a cloud or utility computing system.

The current development of cloud computing services is indicative of a shift away from dedicated systems, to large distributed infrastructure with multiple storage instances. The notion of quality of service management within such an environment has, until now, been only superficially considered. The claimed invention calculates all the parameters needed to provide a service in a cloud environment, not just the parameters specified in a service level agreement (SLA). This process can be applied during the customer provisioning phase, and can be used by Operational System Support Platforms and billing systems to process, configure, and monitor services. The data can be calculated and organized in a data structure, and applied to each service component.

Accordingly, a method is provided for guaranteeing a quality of service (QoS) for a network-connected device in a distributed service platform (DSP) or cloud computing system. The method establishes a first set of attributes or performance criteria for a selected platform component. The selected platform component may be a system component for processing data, or a network component for connecting system components. For example, the first set of attributes may be supplied by a client in an SLA. A second set of attributes is derived for the unselected platform component necessary to support the first set of attributes. For example, if a first set of attributes is established for a system component, then a second set of attributes would be derived or calculated for a network component. As a result, a DSP QoS is supplied to a network-connected (e.g., client) device, guaranteeing the first set of attributes.

More explicitly, a data processing rate limiting factor associated with the first set of network attributes may be derived. Then, each attribute in the second set must be sufficient to support the data processing rate limiting factor.

Some examples of network platform component attributes include central processing unit (CPU) priority, local memory, packets per second (PPS), bandwidth, bus speed, connections per second, and encryption/decryption rate. Some examples of system platform component attributes include CPU priority, local memory, input/output (IO) data rate. If the system is a storage component, additional attributes may include storage redundancy and storage capacity.

Additional details of the above described method, a method for constructing an SLA for a network-connected client, and a device for guaranteeing a QoS in a DSP, are provided below.

### BRIEF DESCRIPTION OF THE DRAWINGS

FIG. 1 is a schematic block diagram depicting a device for guaranteeing a quality of service (QoS) in a distributed service platform (DSP).

FIG. 2 is a diagram depicting the broker of FIG. 1 in the context of a DSP.

FIG. 3 is a flowchart illustrating a method for constructing a service level agreement (SLA) for a network-connected client seeking a guaranteed QoS in a DSP.

FIG. 4 is a schematic diagram depicting the method for constructing an SLA from an alternate perspective.

FIG. 5 is a flowchart illustrating a method for guaranteeing a QoS for a network-connected device in a DSP.

FIG. 6 is a diagram illustrating an alternate perspective of a method for guaranteeing a QoS for a network-connected device in a DSP.

### DETAILED DESCRIPTION

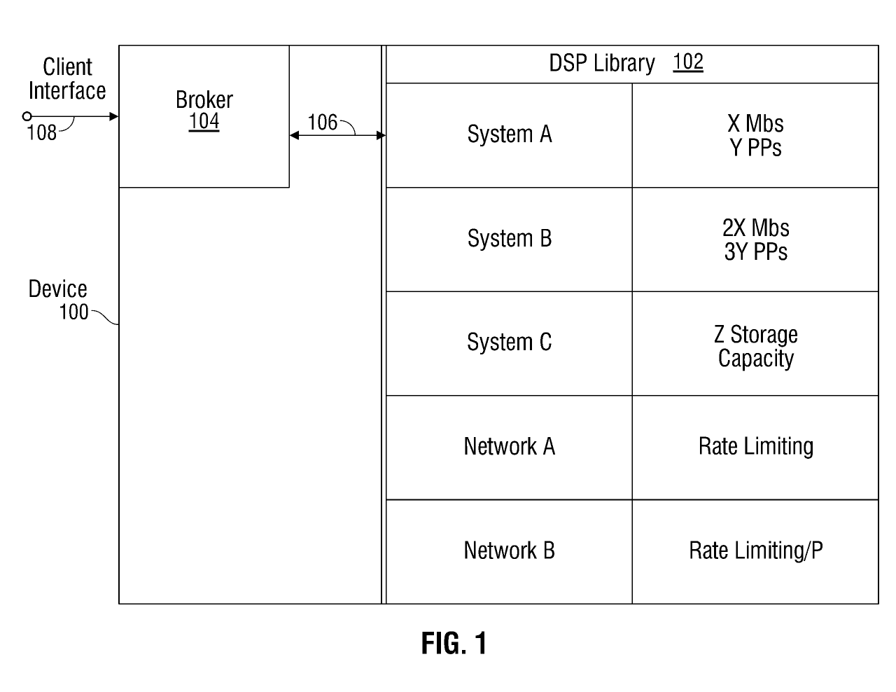

FIG. 1 is a schematic block diagram depicting a device for guaranteeing a quality of service (QoS) in a distributed service platform (DSP). The device 100 comprises a DSP library 102 including DSP system components for processing data, and network components for connecting system components, cross-referenced to component functions. A broker 104 establishes a first set of attributes for a selected platform component. The selected platform can be either a system component for processing data or a network component for connecting system components. The broker 104 has an interface on line 106 to the DSP library 102, accessing limitations (functions) for platform components, and deriving a second set of attributes for an unselected platform component necessary to support the first set of attributes. If the system component is selected, the “unselected” component (associated with the second set of attributes) may be a network component, or the combination of a network component with another (unselected) system component. If the network component is selected, the “unselected” component may be one or more system components.

A network is defined as interconnection between physically distinct services such as storage, servers, other networks, and server applications. A processing system, on the other hand, is one or more independent services connected to a network, such as an application embedded in a server. A system storage component is typically a long-term database storage site.

For example, the broker 104 may have a client interface on line 108 to accept the first set of attributes for the selected platform component. Then, the second set of attributes for the unselected platform component in derived in response to accepting the first set of attributes. After receiving the first set of attributes via the client interface, the broker 104 may establish the first set of attributes in response to accessing functions associated with the selected platform component and compare them to the first set of attributes received via the client interface. This process may entail the examination of several selected platform components, as some components may have functional limitations insufficient to support the first set of attributes.

As shown in this example, the DSP library shows functions associated with system component A, system component B, network component A, and network component B. The functions associated with both system components are bandwidth (BW) and packets per second (PPS). Bandwidth is defined by the egress and ingress volume of data in bit per second to and from a device. Before being transmitted on a network, data are encapsulated into fixed or variable data containers. Each container has a header section with administrative information and a payload section with the data. The containers are called packet or cells depending on the technology. PPS is defined by the number of containers (packet or cell) directed to a device in one second. Typically, performance is “Packet per Second bound” up to a certain size of packet, and “Bandwidth bound” past that point. However, it is conceivable that with technology improvement one of the other could become the only needed parameter.

The function associated with the network equipment is rate limiting. This attribute instructs the equipment to queue the traffic past a certain amount of bits per second and/or packets per second.

Assuming that network A is the selected platform component, meaning that the first set of attributes can be supported by the functions of network A, then the functions associated with the system components are examined. The derivation of the second set of components is actually a two-step process. First, it must be determined if the functions of system A and system B are sufficient to support the first set of attributes. Then, after a system component is selected, the second set of attributes must be derived from the listed functions. For example, the broker may determine a data processing rate limiting factor associated with the first set of network attributes, and select each attribute in the second set sufficient to support the data processing rate limiting factor.

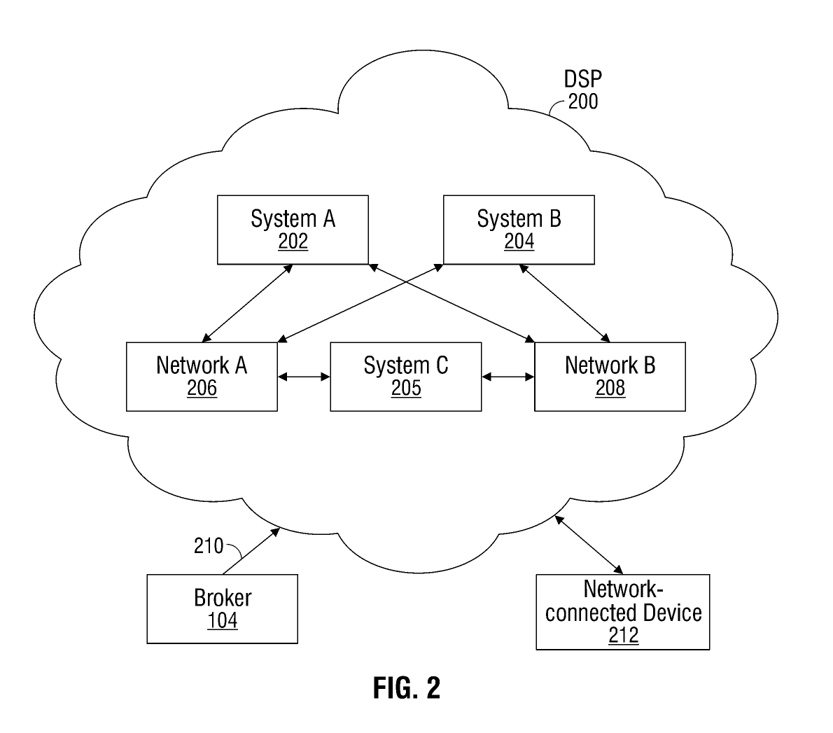

FIG. 2 is a diagram depicting the device of FIG. 1 in the context of a DSP 200. In some aspects, a DSP is understood to be a cloud or utility computing network. The DSP 200 comprises both selected platform component and the unselected platform components. Shown are system A 202, system B 204, system C 205, network A 206, and network B 208. The broker 104 has a DSP interface on line 210 to transmit the first set of attributes to the selected platform component and the second set of attributes to the unselected platform component. As an end result, the DSP 200 supplies a QoS to a client or network-connected device 212, guaranteeing the first set of attributes. The network-connected device 212 may be a module of computer hardware and/or computer software that relies on cloud computing. For example, an iPhone is an example of a mobile client device, while a web browser is an example of a thick client.

Returning to FIG. 1, in addition to system A and system B, which are processing system components, the DSP library 102 also includes a storage system component (system C) cross-referenced to component functions. Then, the first set of attributes can be associated with a network, a processing system, or a storage system component.

Some examples of network platform component attributes include central processing unit (CPU) priority, local memory, packets per second (PPS), bandwidth, bus speed, connections per second, encryption/decryption rate, line card bandwidth, virtual private network (VPN) PPS, and VPN bandwidth. Some examples of system platform component attributes include priority, local memory, input/output (IO) data rate, bus, Southbridge, and Northbridge. If the system is a storage component, some additional attributes may include storage redundancy, storage capacity, total throughput, Fiber channel throughput (if any), CPU, hard drive latency, hard drive read throughput, and hard drive write throughput.

As another example, the broker 104 may establish storage capacity (first set of) attributes for a system storage component and derive a minimum IO data rate (second set of attributes) for a system processing component. Further, the broker 104 may derive a minimum bandwidth and a minimum PPS (second set of attributes) for a network processing component.

NICE and RENICE are examples of process priority attributes. NICE directly maps to a kernel call of the same name. For a given process, it changes the priority in the kernel's scheduler. A niceness of −20 is the highest priority and 19 is the lowest priority. NICE becomes useful when several processes are demanding more resources than the CPU can provide. In this state, a higher priority process will get a larger share of processor cycles than a lower priority process. The related RENICE program can be used to change the priority of a process that is already running.

PPS is a measure of throughput. Typically, it is the average rate of successful data transport container delivery over a communication channel, as defined in bits or bytes per second. More generally, bandwidth defines the maximum amount of information, in bytes or bytes per second, that can be transported via a network or channel. IO data rate refers to the communication rate between an information processing system and a connected unit—a network or another processing system.

Storage redundancy is a measure storage reliability, and it commonly associated with a redundant array of independent disks (RAID) level. Storage capacity is the overall measure of the amount of data bytes in storage.

An attribute defines the characteristics of a device. For example, a network switch might have the following attributes: line capacity, backplane capacity, PPS capacity, bandwidth capacity, and memory capacity. A function, on the other hand, describes the device's abilities—the things that the object is able to do. For example, the functions for a network switch might be: setting PPS rate limiting and setting bandwidth rate limiting. Storage QoS functions include, but are not limited to: storage queuing priority, storage aggregate RAID level, SMART (self-monitoring, analysis, and reporting technology) notification priority, and data replication frequency.

The device and DSP of FIGS. 1 and 2 have been depicted as modules for simplicity. These modules are largely implemented as hardware components that would be well understood by a practitioner in the art. However, elements of the DSP and device may be implemented as microprocessor executable software instructions that are stored in a computer-readable medium.

### Functional Description

Throughout the years the key limiting criteria associated with system and network components has been evolving: some new ones have appeared, and some have disappeared. There are also variations due to manufacturer and model. Therefore, it is difficult to identify any particular attribute or function as the primary rate limiting factor in a collection of components. Generally, an SLA offers a service defined by attributes, which is a layer of abstraction above the functional limitations of the DSP components. Thus, while an SLA and the above-described QoS methods might remain the same, a broker must be informed as how to infer the QoS attributes from system and network component limitations (functions).

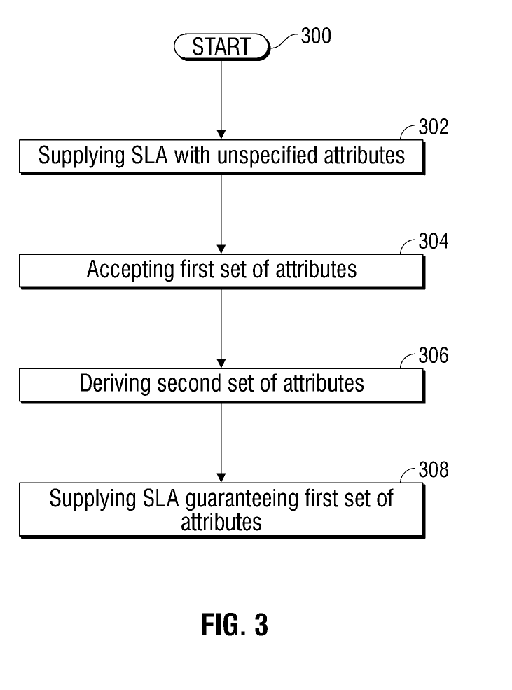

FIG. 3 is a flowchart illustrating a method for constructing a service level agreement (SLA) for a network-connected client'seeking a guaranteed QoS in a DSP. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 300.

Step 302 supplies an SLA without unspecified attributes for DSP network and system components. For example, the SLA may be submitted to a client (user) by a DSP vendor. Alternately, the client may create the SLA document. Step 304 accepts a first set of attributes from a client, for a platform component selected to be either a system component for processing data or a network component for connecting system components. That is, after submitting the SLA form to the client in Step 302, the vendor accepts the DSP SLA with a performance level selected for a particular platform component. However, it should be understood that the SLA does not specify the performance criteria for the other components needed to support the performance-specified component.

Step 306 derives a second set of attributes for the unselected platform component necessary to support the first set of attributes. Step 308 supplies an SLA guaranteeing the first set of attributes. That is, Step 308 supplies a completed SLA. In one aspect, the derived attributes are not expressly stated in the SLA. However as explained above, the first set of attributes cannot be guaranteed with deriving the second set of attributes. Alternately, the SLA may expressly define the second set of attributes. Although only a (single) second set of attributes is derived in Step 306, it should be understood that it may be necessary to derive attributes for a plurality of components that are not specified in Step 304. In that case, Step 306 must derive attribute sets for all the unspecified components.

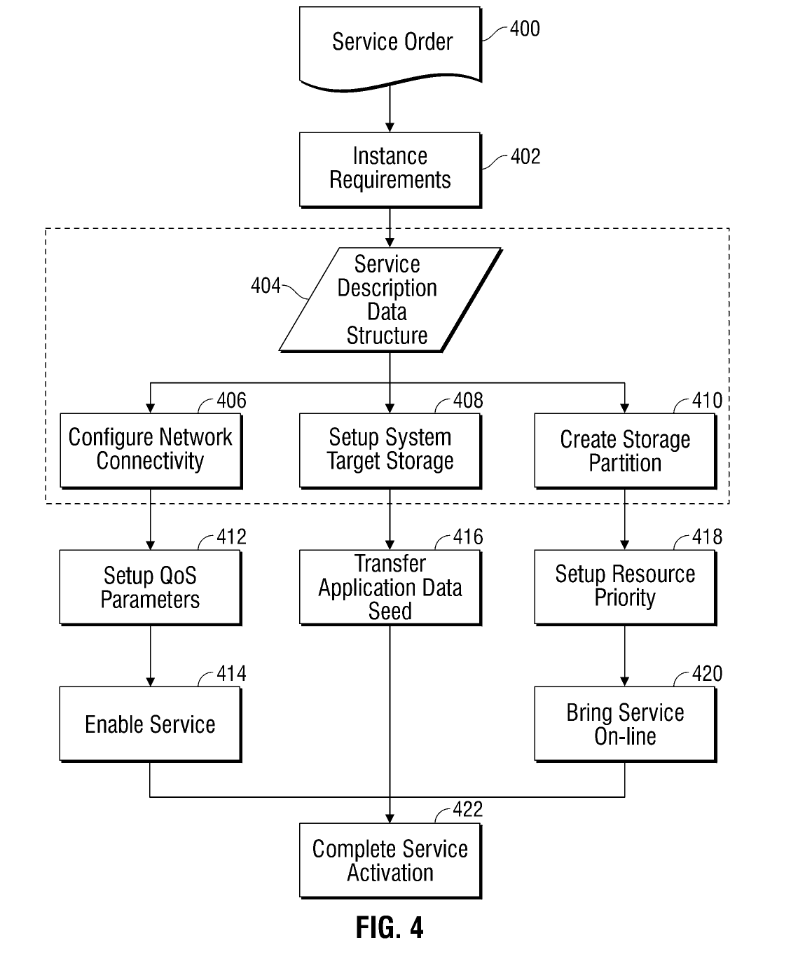

FIG. 4 is a schematic diagram depicting the method for constructing an SLA from an alternate perspective. In Step 400, an SLA form is generated, and in Step 402 the customer is queried to supply attribute specifications (instance requirements) for at least one DSP component. In Step 404 the customer submits the service description data structure, which is the SLA returned with attributes defined for a selected platform component. In Step 406 the network connectivity is configured. In Step 408 the system target storage is set up, and in Step 410 the storage partition is created. Note: if the network attributes are defined in Step 404, Steps 408 and 410 must derive the system storage attributes. Alternately, if the system storage attributes are defined in Step 404, the network attributes must be derived in Step 406.

After the terms and conditions (explicit and implicit) of the SLA are defined, Step 412 sets up the QoS parameters for the network, and Step 414 enables network service. Step 416 instantiates the service into the cloud, Step 418 sets up the storage resource priority, and Step 420 brings the storage component on-line. In Step 422 the service activation is complete, and the customer receives the level of service specified in the SLA.

The following is an example illustrating the competition for resources inherent in a DSP, and illustrates the need to understand all the factors required to supply an end-to-end level of QoS.

For the purpose of this example, a data center is considered providing network file share services with 100 Mbs WAN access, hosting two customers: A and B. The data center is equipped with switches capable of 50,000 PPS and 100 Mbs Ethernet uplinks and downlinks. The filer has currently 100 TB of storage with a 200,000 IO/s capacity. Customer A “owns” 1 terrabyte (TB) of storage and Customer B owns 10 TB of storage on a web application running banking transactions. Customer A starts a full backup of their data across the network using all the available bandwidth. Conventionally, Customer B would receive reduced service performance until Customer A completes their backup, even if Customer B has a 10 TB service agreement. In other words, Customer B is likely to experience a service outage while Customer A performs the backup.

Below is an exemplary calculation showing how the service agreements for both customers can be satisfied by considering all the components in the DSP.

Customer A's QoS service description includes the following attributes:

| | |
|---|---|
| { | |
| CustomerName: Customer A | |
| CustomerID: 0001 | #Customer Unique Identifier |
| CustomerAccountLevel: 6 | #Account Service Quality |
| | (lookup: 6=premium) |
| [...] | |
| Storage_Capacity: 1024GB | #Customer requested capacity 1TB |
| Storage_RedundacyLevel:6 | #Customer Selected Storage |
| | Redundancy |
| Storage_Redundancy: RAID6 | #Translation into RAID level |
| Storage_Service: NFS | #File Service to enable |
| [...] | |
| L2_VLAN_ID: 101 | #Customer Assigned VirtualLAN |
| | ID |
| L2_DSCP_Value:101 | #Set L2 QoS values for this service |
| [...] | |
| IP_Access_BaseCapacity: 1Mbs | #Customer Base Network |
| | Bandwidth for Service |

See below for calculation details

| | |
|---|---|
| IP_Precedence_BaseUse: 3 | #IP Precedence for traffic meeting |
| | the SLA calculated |

For example as a function of the
Account Level and Service default
base precedence

| | |
|---|---|
| IP_Access_Burstable: 100Mbs | # Max burstable BW usage |

calculated here as the Greatest
common denominator between
each network segment

| | |
|---|---|
| IP_Access_Burstable_Precedence:0 | #Drop the precedence to 0 if above |
| | allowed bandwidth. |
| [...] | |
| } | |

Based upon the customer specified storage capacity, IP_Access_BaseCapacity can be calculated as the minimum of the three:
(a) The IO/s capacity on the filer times Customer A “Storage_Capacit,” divided by Total Storage, times the Max minimum transmission unit (MTU) in Mb (1500*8/1024/1024). In this case:

0.01*900000*1500*8/1024/1024=22.9 Mbs
(b) The Greatest Common Denominator of {WAN Mbs capacity, MAN capacity, LAN capacity} times Customer A “Storage_Capacity” divided by the filers Max capacity.

100*0.01=1 Mbs
(c) Minimum overall packet per second of all network equipment times Customer A “Storage_Capacity” divided by the filers Max capacity, times the Max MTU in Mb (1500).

100000*0.01*1500*8/1024/1024=5.72 Mbs

As shown above, the IP Based capacity is a value driven in this case by the filer uplink bandwidth of 1 Mbs.

For Customer B the service descriptor may have the following parameters:

| | |
|---|---|
| { | |
| CustomerName: Customer B | |
| CustomerID: 0002 | #Customer Unique Identifier |
| CustomerAccountLevel: 5 | #Account Service Quality (lookup: |
| | 6=premium) |
| [...] | |
| Storage_Capacity: 10240GB | #Customer requested capacity 1TB |
| Storage_RedundacyLevel:6 | Customer Selected Storage |
| | Redundancy |
| Storage_Redundancy: RAID6 | #Translation into RAID level |
| Storage_Service: NFS | #File Service to enable |
| [...] | |
| L2_VLAN_ID: 102 | #Customer Assigned VirtualLAN |
| | ID |
| L2_DSCP_Value:101 | #Set L2 QoS values for this service |
| [...] | |
| IP_Access_BaseCapacity: 10Mbs | #Customer Base Network |
| | Bandwidth for Service |

See below for calculation details

| | |
|---|---|
| IP_Precedence_BaseUse: 2 | #IP Precedence for traffic meeting |
| | the SLA Calculated |

For example as a function of the
Account Level and Service default
base precedence

| | |
|---|---|
| IP_Access_Burstable: 100Mbs | # Max burstable BW usage |
| | calculated here as the |
| | Greatest common denominator |
| | between each network segment |
| IP_Access_Burstable_Precedence:0 | #Drop the precedence to 0 if above |
| | allowed bandwidth. |
| [...] | |
| } | |

The IP_Access_BaseCapacity can be calculated as the minimum of the three:
(a) The IO/s capacity on the filer times Customer A “Storage_Capacity” divided by Total Storage, times the Max MTU (1500).

0.1*200000*1500*8/1024/1024=220.9 Mbs
(b) The Greatest Common Denominator of {WAN Mbs capacity, MAN capacity, LAN capacity} times Customer A “Storage_Capacity” divided by the filers Max capacity.

100*0.1=10 Mbs
(c) Total minimum packet per second of all network equipment times Customer A “Storage_Capacity” divided by the filers Max capacity, times the Max MTU (1500).

1000000*0.1*1500*8/1024/1024=57.22 Mbs

Following the compilation of the whole descriptor, rate limiting is applied to the facing router and LAN switch of the data center. Without the calculation of non-specified attributes, Customer A would use 99% of the capacity during the backup process leaving Customer B with no resources. With the rate limiting in place, Customer A is able to run their backup at a minimum rate of 1 Mbs and up to 100 Mbs. Customer B is still be able to process transactions at a rate of 10 Mbs minimum and up to 100 Mbs if the bandwidth is available.

At any given time, should Customer A be pulling 100 Mbs over the network and Customer B initiate service activities, Customer A's bandwidth usage is reduced by the amount used by Customer B, up to 10 Mbs. Inherently, Customer A and Customer B are guaranteed a proportional amount of the overall service capacity (1%) and (10%) and, therefore, a more equitable distribution of resources.

As can seen above, each service elements has been defined based on the overall, end-to-end service capacity. Should the service to this customer be moved to different environment, the overall service attributes must be recalculated based on the new equipment characteristics.

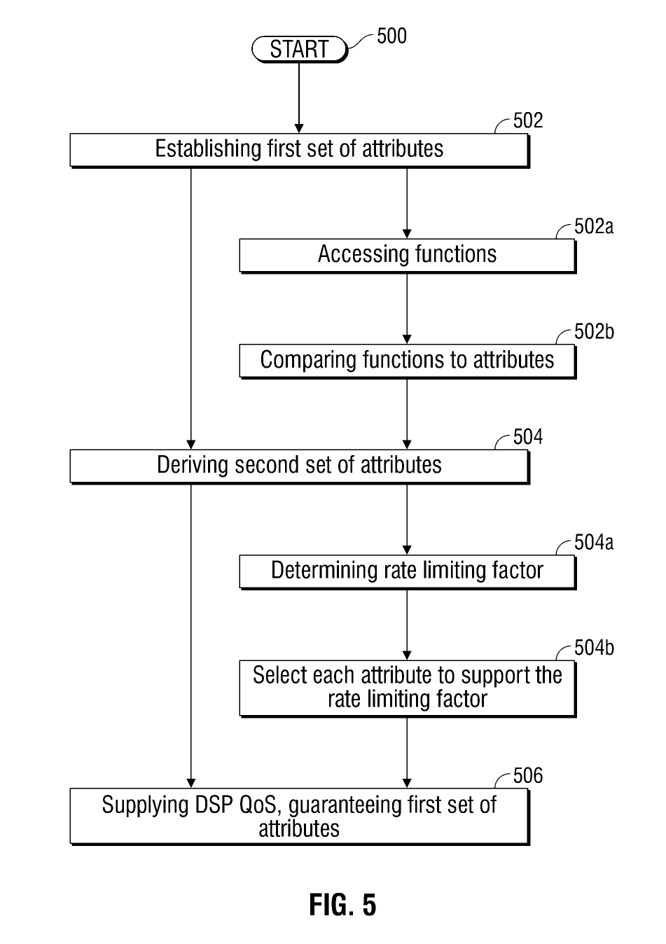

FIG. 5 is a flowchart illustrating a method for guaranteeing a QoS for a network-connected device in a DSP. The method begins at Step 500. Step 502 establishes a first set of attributes for a platform component selected as either a system component for processing data or a network component for connecting system components. In one aspect, the system components can be differentiated as system processing and system storage components. In another aspect, Step 502 establishes the first set of attributes by accepting a first set of attributes for a selected platform component from the network-connected client device. In a different aspect, Step 502 includes substeps. Step 502a accesses functions defining limitations of the selected platform component. Step 502b compares the accessed functions to the first set of attributes. For example, Step 502a and 502b may be required to find a particular component in the DSP capable of support the first set of attributes. The functions of multiple components may be evaluated and compared to the first set of attributes to find the best component match.

Step 504 derives a second set of attributes for the unselected platform component necessary to support the first set of attributes. In one aspect, deriving the second set of attributes for the unselected platform component includes substeps. Step 504a determines a data processing rate limiting factor associated with the first set of network attributes. Step 504b selects each attribute in the second set sufficient to support the data processing rate limiting factor. Step 506 supplies a DSP QoS for a network-connected device, guaranteeing the first set of attributes.

As noted above, network platform component attributes include CPU priority, local memory, PPS, bandwidth, bus speed, connections per second, encryption/decryption rate, line card bandwidth, VPN PPS, and VPN bandwidth. Some examples of system platform component attributes include priority, local memory, IO data rate, bus, Southbridge, and Northbridge. If the system is storage component, some additional attributes may include storage redundancy, storage capacity, total throughput, Fiber channel throughput, CPU, hard drive latency, hard drive read throughput, and hard drive write throughput.

For example, if establishing the first set of attributes in Step 502 includes establishing storage capacity attributes for a system storage component, then deriving the second set of attributes in Step 504 may include deriving a minimum IO data rate for a system processing component. Further, Step 504 may derive a minimum bandwidth and a minimum PPS for a network processing component.

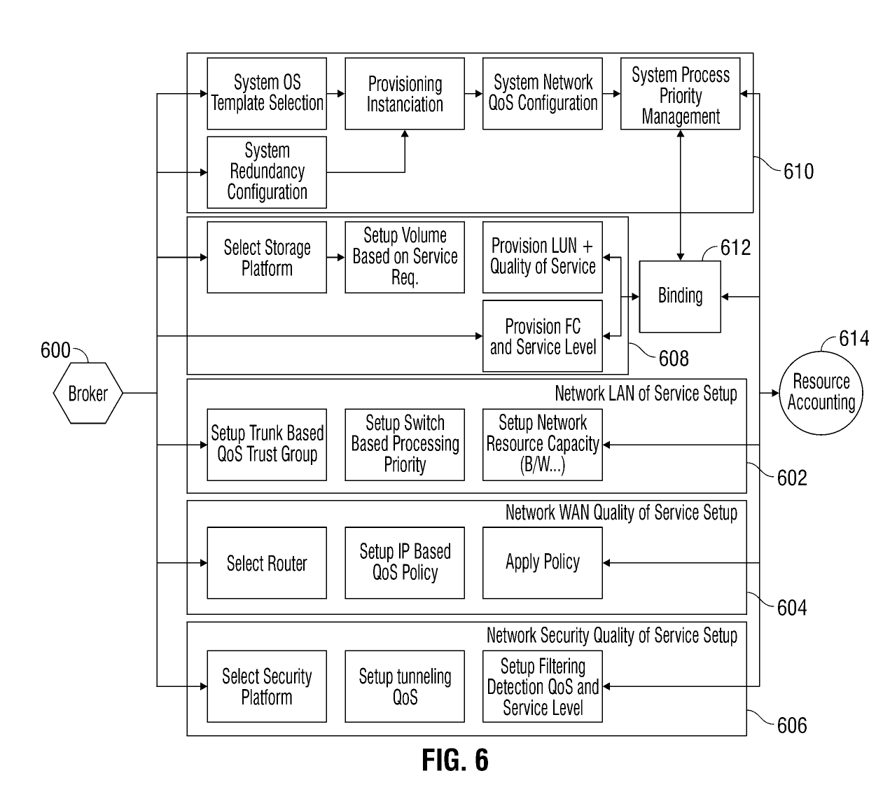

FIG. 6 is a diagram illustrating an alternate perspective of a method for guaranteeing a QoS for a network-connected device in a DSP. A broker 600 accepts an SLA with a specified first set of attributes. First, the network component is established. Block 602 depicts the factors for establishing a local area network (LAN). Namely, the trunk based trust group, switch, and network resources are set up. Block 604 depicts the factors for establishing a wireless area network (WAN). Namely, the router and IP based QoS policies are set up. Block 606 depicts the factors for establishing a network security QoS. Namely, the security platform, tunneling QoS, and filtering/detection QoS service levels are set up.

In block 608, the storage platform establishes volume, logical unit number (LUM) fiber channel (FC), and service level attributes. In block 610, system OS, redundancy, QoS, and priority levels are established. The performance criteria for the three component levels are bound in block 612, and accounting for the supplied services in applied in block 614.

In Virtualized storage, the physical hard drives (HDs) are setup in an aggregate. Each aggregate is partitioned into several volumes. Each volume is provided with a unique identifier named in the small computer system interface (SCSI) world LUN. The names for these functions may vary according to the explicit technology.

Returning to the provisioning procedure of block 608, the storage is picked based on its capacity and capabilities. The storage is already setup with an aggregate (this is typically done when the system is first setup). The aggregate is picked based on the RAID level requested. A volume is created on top of aggregate. A LUN is assigned to the volume and the storage service level is assigned. In parallel the above-described steps, the Fiber Channel switch is setup, the service level on the switch is also adjusted for queue priorities. Note that the FC could be construed as a type of network device. It is typically associated with storage since only storage is actually using this technology for transport.

A device and methods have been provided for guaranteeing a QoS for a network-connected device in a DSP. Examples of components, attributes, and functions, as well as the relationship between various attributes and functions, have been provided to illustrate the invention. However, the invention is not necessarily limited to these examples. Other variations and embodiments of the invention will occur to those skilled in the art.

We claim:

1. In a distributed service platform (DSP), a method for guaranteeing a quality of service (QoS) for a network-connected device, the method comprising:
establishing a first set of attributes for a platform component selected from a group consisting of a system component for processing data and a network component for connecting system components;
deriving a second set of attributes for the unselected platform component necessary to support the first set of attributes; and,
supplying a DSP QoS for a network-connected device, guaranteeing the first set of attributes.

2. The method of claim 1 wherein establishing the first set of attributes includes establishing a first set of attributes for a platform component selected from a group consisting of a network, a processing system, and a storage system component; and,
wherein deriving the second set of attributes includes deriving attributes for each unselected platform component necessary to support the first set of attributes.

3. The method of claim 1 wherein deriving the second set of attributes for the unselected platform component includes:
determining a data processing rate limiting factor associated with the first set of network attributes; and,
selecting each attribute in the second set sufficient to support the data processing rate limiting factor.

4. The method of claim 1 wherein establishing the first set of attributes includes establishing a first set of attributes for a system component; and,
wherein deriving the second set of attributes includes deriving a second set of attributes for a network platform component, where the second set of attributes is selected from a group consisting of central processing unit (CPU) priority, local memory, packets per second (PPS), bandwidth, bus speed, connections per second, and encryption/decryption rate.

5. The method of claim 1 wherein establishing the first set of attributes includes establishing a first set of attributes for a network component;
wherein deriving the second set of attributes includes deriving a second set of attributes for a system platform component, where the second set of attributes is selected from a group consisting of CPU priority, local memory, input/output (IO) data rate.

6. The method of claim 2 wherein establishing the first set of attributes includes establishing a first set of attributes for a network component;
wherein deriving the attributes for each unselected platform component includes deriving a set of attributes for a system storage component, where the attributes is selected from a group consisting of CPU priority, local memory, IO data rate, storage redundancy, and storage capacity.

7. The method of claim 2 wherein establishing the first set of attributes includes establishing storage capacity attributes for a system storage component; and,
wherein deriving the second set of attributes includes deriving a minimum IO data rate for a system processing component.

8 The method of claim 7 wherein deriving the second set of attributes includes deriving a minimum bandwidth and a minimum PPS for a network processing component.

9. The method of claim 1 wherein establishing the first set of attributes includes accepting a first set of attributes for a selected platform component from the network-connected client device.

10. The method of claim 9 wherein establishing the first set of attributes further includes:
accessing functions defining limitations of the selected platform component; and,
comparing the accessed functions to the first set of attributes.

11. A method for constructing a service level agreement (SLA) for a network-connected client seeking a guaranteed quality of service (QoS) in a distributed service platform (DSP), the method comprising:
supplying an SLA without unspecified attributes for DSP network and system components;
accepting a first set of attributes from a client, for a platform component selected from a group consisting of a system component for processing data and a network component for connecting system components;
deriving a second set of attributes for the unselected platform component necessary to support the first set of attributes; and,
supplying an SLA guaranteeing the first set of attributes.

12. The method of claim 11 wherein supplying the SLA guaranteeing the first set of attributes includes additionally guaranteeing the second set of attributes.

13. A device for guaranteeing a quality of service (QoS) in a distributed service platform (DSP), the device comprising:
a DSP library including DSP system components for processing data, and network components for connecting system components, cross-referenced to component functions; and,
a broker establishing a first set of attributes for a platform component selected from a group consisting of a system component for processing data and a network component for connecting system components, the broker having an interface to the DSP library to access limitations for platform components, and deriving a second set of attributes for the unselected platform component necessary to support the first set of attributes.

14. The device of claim 13 further comprising:
a DSP including the selected platform component and the unselected platform component;
wherein the broker has a DSP interface to transmit the first set of attributes to the selected platform component and the second set of attributes to the unselected platform component; and,
wherein the DSP supplies a QoS to a client, guaranteeing the first set of attributes.

15. The device of claim 13 wherein the DSP library includes a processing system component and a storage system component, cross-referenced to component functions;
wherein the broker establishes a first set of attributes for a platform component selected from a group consisting of a network, a processing system, and a storage system component, and derives attributes for each unselected platform component necessary to support the first set of attributes.

16. The device of claim 13 wherein the broker determines a data processing rate limiting factor associated with the first set of network attributes, and selects each attribute in the second set sufficient to support the data processing rate limiting factor.

17. The device of claim 13 wherein the broker establishes a first set of attributes for a system component and derives a second set of attributes for a network platform component, where the second set of attributes is selected from a group consisting of central processing unit (CPU) priority, local memory, packets per second (PPS), bandwidth, bus speed, connections per second, and encryption/decryption rate.

18. The device of claim 13 wherein the broker establishes a first set of attributes for a network component and derives a second set of attributes for a system platform component, where the second set of attributes is selected from a group consisting of CPU priority, local memory, input/output (IO) data rate.

19. The device of claim 15 wherein the broker establishes a first set of attributes for a network component and derives a set of attributes for a system storage component, where the derived set of attributes is selected from a group consisting of CPU priority, local memory, IO data rate, storage redundancy, and storage capacity.

20. The device of claim 15 wherein the broker establishes storage capacity attributes for a system storage component and derives a minimum IO data rate for a system processing component.

21. The device method of claim 20 wherein the broker derives a minimum bandwidth and a minimum PPS for a network processing component.

22. The device of claim 13 wherein the broker has a client interface to accept the first set of attributes for the selected platform component, and derives the second set of attributes for the unselected platform component in response to accepting the first set of attributes.

23. The device of claim 22 wherein the broker establishes the first set of attributes in response to accessing functions associated with the selected platform component and comparing them to the first set of attributes received via the client interface.
